(19) United States
(12) Patent Application Publication
(10) Pub. No.: US 2013/0257680 A1
(43) Pub. Date: Oct. 3, 2013

(54) ANTENNA ASSEMBLY FOR A WIRELESS COMMUNICATIONS DEVICE

(71) Applicants: Andrew Nix, Bristol (GB); Ioannis Askaroglou, Bristol (GB)

(72) Inventors: Andrew Nix, Bristol (GB); Ioannis Askaroglou, Bristol (GB)

(73) Assignee: GI PROVISION LIMITED, Bristol (GB)

(21) Appl. No.: 13/808,828

(22) PCT Filed: Jul. 7, 2011
(86) PCT No.: PCT/GB11/51274

§ 371 Date: Jun. 19, 2013

(30) Foreign Application Priority Data
Jul. 7, 2010 (GB) 1011470.0

(51) Int. Cl. H01Q 21/29; H01Q 21/24; H01Q 9/04; H01Q 1/50

(52) U.S. Cl. CPC H01Q 21/29; H01Q 1/50; H01Q 21/24; H01Q 9/04
USPC 343/876; 343/893

(57) ABSTRACT

An antenna assembly for a wireless communications device and/or system, the assembly comprising a first antenna having a first direction of maximum radiated power; and a second antenna having a second direction of maximum radiated power, wherein the first and second antenna are arranged such that the first and second directions are substantially mutually orthogonal. Also, provided is an antenna assembly having a third or more antenna having a third or further direction of maximum radiated power, wherein the third or more antenna is/are arranged such that the third or further directions is/are substantially orthogonal with the first and second directions.

The present invention relates to an antenna assembly for use in a wireless communications device. In particular, although not necessarily exclusively, the present invention relates to an antenna assembly for use in a wireless communications device which operates in an indoor environment.

Consumer electronic products provided with wireless standards IEEE 802.11n for connectivity are becoming increasingly common. For Wireless Local Area Network (WLAN) products used within the home, the WLAN devices are being provided with multiple antennas to support the Multiple Input Multiple Output (MIMO) features of the 802.11n standard.

The differences in performance of WLAN devices, when located within, for example, the home or an office environment, tend to relate to the rate at which data can be received by each device which in turn can depend on the different locations within the home that the products are placed. As a result, such WLAN products can have a poor and/or variable data throughput rate.

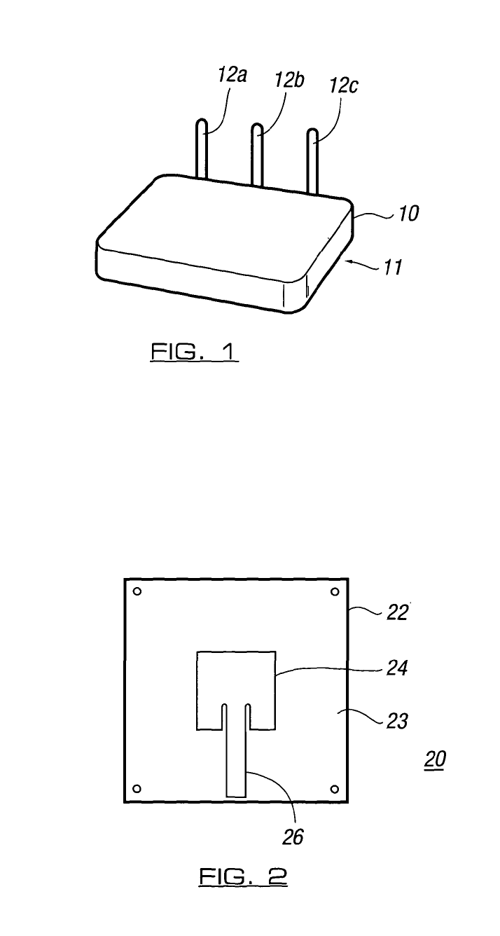

To receive and transmit the data signals wirelessly, the WLAN devices are provided with one or more antennas. Commonly, the WLAN devices are provided with relatively simple external antennas. An example of such a conventional WLAN device, ideal for use in an environment such as in a home, can be seen in FIG. 1 which shows a MIMO (multiple input multiple output) wireless router 10 which is typically positioned on a horizontal surface such as a desk (not shown) so that face 11 is adjacent to and in parallel with the surface. The router 10 is provided with three external antennas 12a, b, c which are mounted spaced apart and projecting vertically in relation to the orientation of the router 10 and the surface upon which it is resting. The antennas 12a, b, c typically have a gain of the order of 3 dB which can be considered relatively low. By mounting the antennas 12a, b, and c vertically, such that they are perpendicular to the router 10, the antennas 12a, b, and c are omnidirectional in the azimuth. In routers such as router 10, the spatial separation of antennas 12a, b, and c provides the benefit of some received signal de-correlation being possible.

In other types of conventional WLAN devices, simple, low-gain antennas are mounted within the plastic enclosure of the WLAN device. In a yet further type of WLAN device, simple, low gain antennas are integrated with the main Printed Circuit Board (PCB).

Other WLAN devices provided with complex multiple antenna arrays are also known wherein the array can dynamically switch between the antennas, in dependence upon a predetermined criteria such as, for example, signal strength, to optimize data throughput. The antennas within these arrays are arranged so as to have horizontal polarization and provide the WLAN device with omni-directional coverage.

As can be seen from the examples detailed above, typically, the direction of maximum radiated power of each individual antenna is generally in the horizontal plane in the sense that it is in parallel with the horizon. Furthermore, the antennas are typically arranged such that there is complete coverage in azimuth. Transmission in the horizontal plane has, for wireless applications in indoor environments, been favoured as transmission of horizontally polarized radio frequency (RF) signals is more efficient than transmission of vertically polarized RF signals in an indoor environment. In addition, the wireless receivers of most devices used within an indoor environment, such as laptop computers, have horizontally polarized antennas.

However it is found that in practice these known devices provide relatively poor or variable performance such that for each location of use there can be uncertainty as to the level of performance which will be achieved and the devices are sensitive to features of the surrounding environment which can affect their performance such as power supplies, heat sinks and the like. Therefore, there is a need for the provision of an antenna assembly which addresses the problems and/or limitations of the prior art and it is therefore an aim of the present invention to obviate or mitigate at least one of the aforementioned problems.

According to a first aspect of the invention there is provided an antenna assembly for a wireless communications device, the assembly comprising a first antenna having a first direction of maximum radiated power; and a second antenna having a second direction of maximum radiated power, wherein the first and second antennas are arranged such that the first and second directions are substantially mutually orthogonal.

The arrangement of the first and second antennas to be mutually orthogonal enables the antenna assembly to provide a wireless communication link with reduced cross correlation and increased spatial diversity, particularly within an indoor environment.

Preferably, the first and second antennas have respective directions of polarisation, and wherein those directions of polarisation are substantially mutually orthogonal.

In one embodiment, the antenna assembly further comprises a third antenna having a third direction of maximum radiated power, wherein the third antenna is arranged such that the third direction of maximum radiated power is substantially orthogonal to the first and second directions.

In such an embodiment, preferably the third antenna has a direction of polarisation which is substantially orthogonal to each of the first and second directions of polarisation.

The provision of orthogonal polarisation of the first and second antennas further reduces cross correlation, particularly when used in a wireless network hub such as a MIMO modem.

In one embodiment the assembly can be operable to select for operation a subset of the antennas, the subset comprising antennas that have substantially mutually orthogonal directions of maximum radiated power.

By enabling a subset of antennas to be selected enables the assembly, whilst in use, to ensure the wireless signal provision is maximised for the particular location in which the same is provided to be operated.

Each antenna may be a high gain antenna and, consequently, a directional antenna. These antenna features will facilitate optimisation of antenna function particularly when used in an indoor environment wherein the wireless signal may be subject to multiple reflections and/or diffractions off interior surfaces such as walls and ceilings.

In one embodiment the assembly is provided as a body having one or more faces and the antennas are provided on respective faces of the body. In one embodiment each antenna may be provided on respective surfaces of a cube or cuboid shaped body.

Each antenna may be resonant in a single band of frequencies. In another embodiment the antenna may be resonant at dual frequencies thus increasing operational bandwidth. An additional benefit is that the effects of antenna detuning due to mounting of the antennas within a body of the assembly are reduced.

In one embodiment the antenna assembly can be provided with up to six antennas and in one configuration antennas provided on opposing surfaces of a cube may have respective polarisation which are on a shared axis but in opposing directions. This enables the antenna assembly to maximise provision of a wireless link whilst ensuring efficiency and minimising cross correlation.

The antenna assembly may be implemented in a transmitter device or a receiver device and thus the wireless link provision can be maximised in products having either or both types of device.

According to a second aspect of the invention there is provided a wireless communications device comprising an antenna assembly as detailed with reference to the first aspect of the invention. The provision of the antenna assembly in a wireless communications device may enable improved wireless signal links to be provided by the said communications device, thereby optimising performance of such devices.

Typically in the current invention there are provided no or minimal overlapping peaks of performance from each antenna so that in on embodiment, at a given location there is only one antenna performing which is performing significantly more strongly than the other antennas and so the power of each antenna does not need to be adjusted or compromised to take into account possible effects on the performance of the other antennas as is the case with the conventional omnidirectional antenna arrays where compromise in the performance of each of the antennas is often required.

In one embodiment the circuit boards and antenna are provided in an an overlapping arrangement in the assembly.

These and other aspects of the invention will now be described, by way of example only, and with reference to the accompanying drawings, in which:

FIG. 1 illustrates a known wireless transmission device;

FIG. 2 illustrates an example of a patch antenna unit for use in a wireless communication device of the present invention;

FIG. 3 illustrates a first embodiment of a wireless antenna assembly according to a first aspect of the present invention;

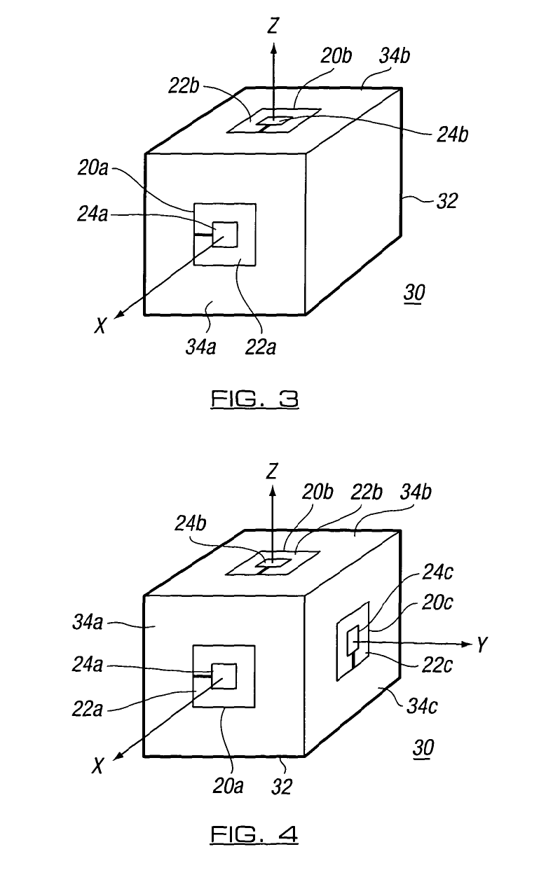

FIG. 4 illustrates a second embodiment of a wireless antenna assembly according to a first aspect of the invention;

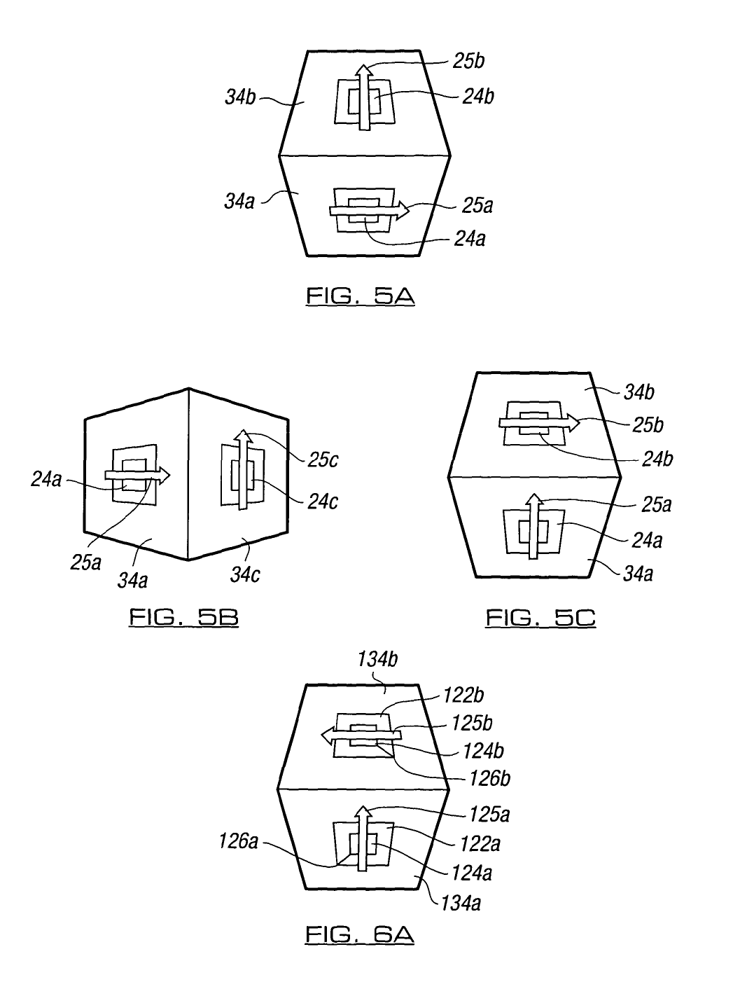

FIG. 5A illustrates schematically a first embodiment of a polarisation pattern of the wireless antenna assembly of FIG. 4;

FIG. 5B illustrates schematically a second embodiment of a polarisation pattern of the wireless antenna assembly of FIG. 4;

FIG. 5C illustrates schematically a third embodiment of a polarisation pattern of the wireless antenna assembly of FIG. 4;

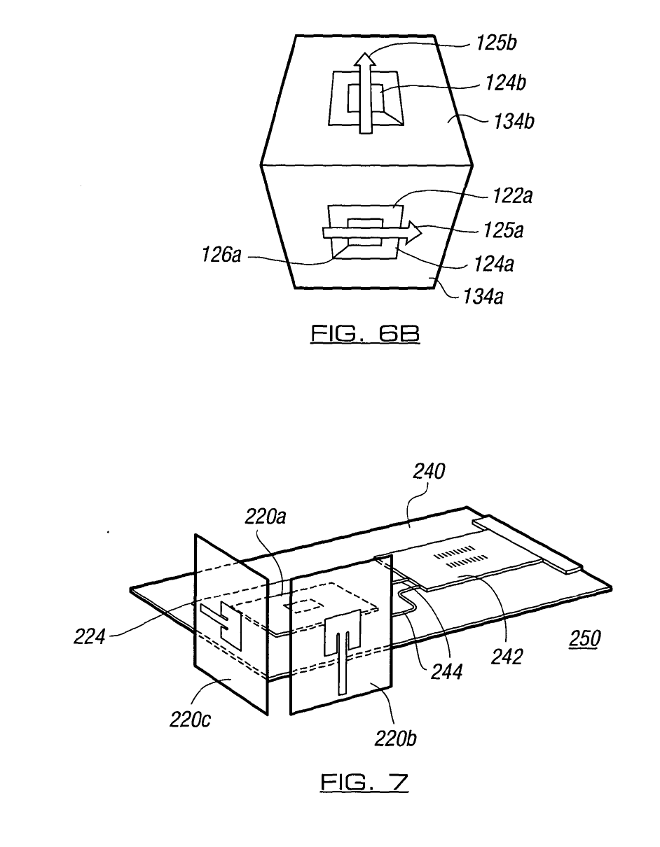

FIG. 6A illustrates the direction of polarisation in a first frequency band of operation of a dual resonant wireless antenna assembly according to a second aspect of the invention;

FIG. 6B illustrates the rotation of polarisation with respect to FIG. 6A in a second frequency band of operation of a dual resonant wireless antenna assembly according to a second aspect of the invention;

FIG. 7 illustrates a wireless communications device including a wireless antenna assembly according to a third aspect of the invention;

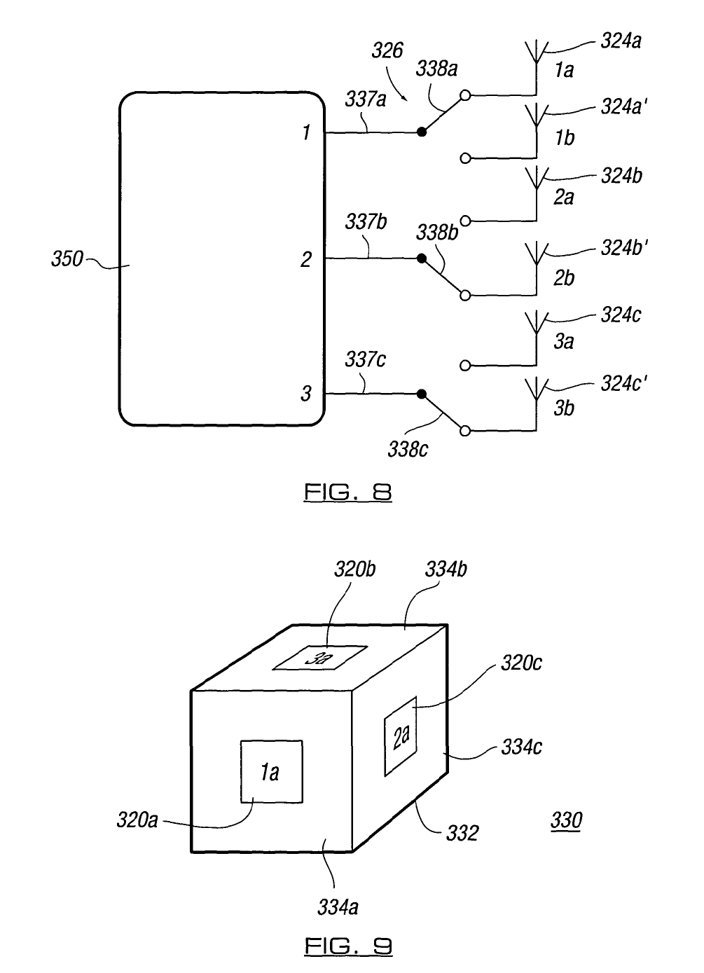

FIG. 8 illustrates a schematic representation of a wireless antenna assembly according to a fourth aspect of the invention implemented in a wireless communications device; and

FIG. 9 illustrates a wireless antenna assembly of FIG. 8.

With reference to FIG. 2 there is shown a single resonant patch antenna unit 20. The patch antenna unit 20 comprises an antenna unit base 22 which is provided with a square patch antenna 24 which is directional, high-gain and efficient. The antenna 24 is provided with a feed point 26. In the case of a dual resonant variant, the patch 24 is slightly rectangular and the feed point 24 is adjusted. The provision of a dual resonant design allows an increase in bandwidth to avoid detuning becoming a problem. In one embodiment it is possible to select between higher or lower bands if operation which can be useful in certain systems. The surface (not shown) of the unit base 22 opposing the surface 23 on which the antenna 24 is mounted is, in this case, planar. A benefit of this arrangement is that the performance of the antenna is not affected by the internal circuitry of the modem. The antenna unit base 22 is, in this embodiment, formed of copper laminate material with a low-loss substrate such as one based on polytetrafluoroethylene (PTFE) which has a low dissipation factor. By choosing a substrate material for antenna base unit 22 which minimizes power lost to heat, the efficiency of the antenna unit 20 can be maximized and therefore the maximum gain of the antenna unit 20 is increased. The antenna 24 is, in this case, fabricated using PCB material with a substrate based on PTFE however any substrate material commonly used to form PCBs such as, but not limited to, FR4 fibreglass can be used.

With reference to FIG. 3 there is shown an embodiment of a wireless antenna assembly 30 comprising a wireless network unit 32 which is in this embodiment a hollow cube of a suitable plastics material such as, but not limited to, high density polyethylene, of which surfaces 34a, 34b and 34c can be seen. Surface 34a is orientated as to be orthogonal to the x-axis; surface 34b is orientated to be orthogonal to the z-axis and surface 34c is orientated to be orthogonal to the y-axis. Upon each of surfaces 34a and 34b is provided an antenna unit 20 as shown in FIG. 2 with, in this case, patch antenna units 20a and 20b located in the centre of the corresponding surfaces 34a,b. The antenna 24a is arranged orthogonally to antenna 24b. However, it will be appreciated that the patch antenna unit placement need not be limited to the centre of the corresponding surface.

In use within a wireless network system (not shown) the high gain antennas 24a,b of the wireless antenna assembly 30 result in a good quality received signal strength which results in high rates for data throughput and a good signal transmission range. As gain will be low in the y direction as well as reciprocal directions −x, −y and −z, when used within a free space environment, such as outdoors, the wireless antenna assembly will require to be oriented to ensure that the transmission from antennas 24a and 24b are directed towards the devices (not shown) in communication with the wireless antenna assembly 30 in order to achieve best performance of wireless data transmission. However, when in use within an indoor environment the wireless antenna assembly 30 can be orientated randomly with respect to the client devices (not shown) as the transmission from high gain antennas 24a, 24b are subject to multiple reflections within a building, in conjunction with the MIMO processing of the radio signals resulting in a improved quality data throughput rate. Doubled throughput rates have been demonstrated when the antenna assembly 30 is applied to the transmitter only, and further performance increases, for example, triple throughput rates, have been observed when the antenna assembly 30 is applied at both the transmitter and the receiver. Furthermore, as the directions of maximum antenna gain are in the vertical plane (orthogonal to the z-axis) and first horizontal plane (orthogonal to the x-axis), the wireless antenna assembly 30 provides improved signal provision and thus coverage in an indoors environment which is of particular value in buildings having more than one floor level. The spatial separation of the orthogonally arranged antennas 24a and 24b provides a reduction in cross correlation in the transmitted signals as well as an increase in spatial diversity thus increasing the quality and reliability of the wireless data transfer. As WLAN wireless network cards (not shown) typically output a limited power per transmit chain to allow economical implementation of the wireless network with maximum linearity of the power amplifiers within the network card. The use of highly directional antennas such as antennas 24a,b enables the gain per transmit chain, thus total Equivalent Isotropic Radiated Power (EIRP), to be significantly higher than would be expected from use of omnidirectional antennas. The use of a high gain antenna unit 20 results in a narrow beamwidth for the antennas 24a, b, which means the angle of the antenna pattern over which the relative power is at or above 50% of the peak power is relatively narrow.

However, in use in an assembly 30, the relatively narrow beamwidth will contribute to the reduction in cross-correlation between antennas 24a and 24b. Furthermore, whilst the provision of a narrow beamwidth can prevent the antenna unit 30 providing omnidirectional coverage, the increased antenna gain results in an improved signal strength which means omnidirectional coverage is not a necessity.

As transmission from, and reception to, an equally polarized pair of antennas is significantly better than transmission from, and reception to, an unequally polarized pair of antennas, the antennas 24a and 24b are, in this case, equally polarized for the transmitter and corresponding receiver. Furthermore, whilst capitalising on the benefit of better transmission and reception gained by having antennas 24a and 24b equally polarized, the adjacent antennas 24a and 24b also have different polarizations to keep cross correlation between the signals at a minimum. By assigning antennas 24a, 24b, having alternate, perpendicular, polarisations, to adjacent faces 33a, 34b of a antenna unit 32 which is a cube shape, such that the antennas 24a, 24b have different directions in azimuth and elevation and the directions of maximum radiated power are mutually orthogonal, enables the antenna assembly 30 to operate effectively, particularly when used in a MIMO modem.

With reference to FIG. 4 there is shown another embodiment of a wireless antenna assembly 30 comprising a wireless network unit 32 which is a cube of which surfaces 34a, 34b and 34c can be seen, with surface 34a orientated as to be orthogonal to the x-axis; surface 34b orientated to be orthogonal to the z-axis and surface 34c orientated to be orthogonal to the y-axis. Upon each of surfaces 34a, 34b and 34c is provided an antenna unit 20 as shown in FIG. 2 with, in this case, patch antenna units 20a, 20b and 20c located in the centre of the corresponding surface 34a, b, and c. The antennas 24a, 24b and 24c are arranged orthogonally to one another such that, in use, the directions of maximum radiated power from the wireless antenna assembly 30 are mutually orthogonal. In this embodiment, the directions of maximum gain are along the x, y and z axes.

The antenna units 20a-c of the assembly 30 of FIG. 5 are mounted upon unit 32 in such a way that where two of antennas 24a-c are adjacent, the polarisation of the adjacent antennas, such as, for example 24a and 24c, differ by 90°. Illustrations of the polarisation of the adjacent antennas of FIG. 4 are shown in FIGS. 5A, 5B and 5C. In FIG. 5A, the top surface 34b and the front surface 34a of unit 32 are shown. As can be seen, the polarisation 25a, represented by an arrow, of antenna 24a mounted on surface 34a is orientated in the direction of the y-axis. The polarisation 25b of antenna 24b, mounted on surface 34b is in the direction of the reciprocal −x-axis. In FIG. 5B, the front surface 34a and side surface 34c of unit 32 are shown. As can be seen, the polarisation 25a, represented by an arrow, of antenna 24a mounted on surface 34a is orientated in the direction of the y-axis and the polarisation 25c, represented by an arrow, of antenna 24c mounted on surface 34c is orientated in the direction of the z-axis. In FIG. 5C, the side surface 34c and the top surface 34b of unit 32 are shown. As can be seen, the polarisation 25b, represented by an arrow, of antenna 24b mounted on surface 34b is, as before, orientated in the direction of the reciprocal −x axis and the polarisation 25c, represented by an arrow, of antenna 24c mounted on surface 34c is orientated in the direction of the z-axis. The antenna directions vary in both azimuth and elevation.

With reference to FIGS. 6A and 6B there is shown a further embodiment of the wireless assembly 30 comprising a wireless network unit 32 which is a hollow cube of a suitable plastic material such as, but not limited to, high density polyethylene, of which surfaces 34a, 34b and 34c can be seen. Surface 34a is orientated as to be orthogonal to the x-axis; surface 34b is orientated to be orthogonal to the z-axis and surface 34c is orientated to be orthogonal to the y-axis. Upon each of surfaces 34a, and 34b is provided an antenna unit 120 comprising an antenna unit base 122 which is provided with a rectangular antenna 124 which is directional, high-gain and efficient. The surface (not shown) of the unit base 122 opposing the surface 123 on which the antenna 124 is mounted is, in this case, planar. The antenna unit base 122 is, in this embodiment, formed of copper laminate material with a low-loss substrate such as one based on polytetrafluoroethylene (PTFE) which has a low dissipation factor. By choosing a substrate material for antenna base unit 122 which minimizes power lost to heat, the efficiency of the antenna unit 120 can be maximized and therefore the maximum gain of the antenna unit 120 is increased. The antenna 24 is, in this case, fabricated using PCB material with a substrate based on PTFE however any material commonly used to form PCBs such as, but not limited to, FR4 fiberglass can be used. In this embodiment, patch antenna units 120a, 120b are located in the centre of the corresponding surfaces 34a, 34b. The antennas 124a, 124b are arranged orthogonally to one another. Antennas 124a, 124b are, in this case resonant in dual frequencies thus the antenna polarisation, represented by arrows 125a, 125b respectively, changes by 90 degrees as the frequency is changed from the first resonance to the second.

In FIG. 6A, there is shown a first rotation of polarisation between frequency modes in a first mode of operation with polarisation 125a in the direction of the z axis and polarisation 125b in the direction of the reciprocal −y axis. In FIG. 6B there is shown a second rotation of polarisation between frequency modes in a second mode of operation with polarisation 125a in the direction of the y axis and polarisation 125b in the direction of the reciprocal −x axis. As can be seen, in this embodiment, the rectangular antennas 124a, 124b are provided with respective feed points 126a, 126b. In the arrangement of antennas 124a, 124b the 90° difference in polarisation between adjacent antennas is maintained during any change in resonance. In use, this arrangement of antennas 124a, 124b results in an increased bandwidth being available as a result of dual resonance, whilst the benefits of directionality and polarisation are also available.

It will be clearly understood that the above embodiments of the wireless antenna assembly 30 apply to its use as a transmitter or a receiver antenna and can be used, with corresponding benefit, in any number of wireless networking products (not shown) within a wireless network system (not shown). For maximum performance from the wireless antenna assembly, both the access point product of the wireless system and any product in communication with the access point are each equipped with an antenna assembly 30 to ensure there will always be a receive antenna 30 with the same polarisation as a transmit antenna 30 whilst the cross correlation between the antenna 30 within a wireless system at each end of the wireless link remains minimised.

Whilst FIG. 3, FIGS. 4A, B and C, FIG. 5 and FIGS. 6A and B show a wireless antenna assembly 30 having the antenna units 20a, 20b and 20c, or 120a,120b located respectively on the outer surfaces 34a, 34b, 34c of the wireless network unit 32, it will be clearly understood that when manufactured for use in a consumer product, the antenna units 20a, 20b and 20c or 120a, 120b can be placed on the corresponding inner surface (not shown) thus resulting in a more robust wireless antenna assembly as the antennas 20a, 20b and 20c or 120a,120b will be afforded protection from general wear and tear by the outer surfaces 34a, 34b and 34c. However, it will be understood that by arranging the antenna units 20a-c or 120a, 120b within the enclosure of the unit 32, it will be necessary to adjust the dimensions of the antennas 20a-c or 120a, 102b to correct for detuning due to the effect of their enclosure by the unit 32.

However, there can be practical drawbacks to mounting antennas 20a,b,c or 120a,c on the inside surfaces of a network unit 32 as this imposes additional and extended requirements on the size of the network unit cube 32 as well as imposing limitations on the form factor of the network unit 32. In addition, depending on the shape size and location of the assembly 30, the wiring of coaxial cables (not shown) from the antennas 20a, b, c or 120a, and b to the main PCB of the wireless product (not shown) in which the assembly 30 is provided may be extensive and complex. In particular, the connectors commonly used for connecting a coaxial cable to a PCB are expensive and the process of connection involves manual assembly work which not only adds to the cost of manufacture but increases the risk of defects.

During manufacture of the antenna assemblies, the antenna units 20 can be placed such that the limitations imposed by the antenna units 20 on the form of the antenna assembly is minimised thus reducing the manufacturing defect rate and reducing the manufacturing cost. An embodiment of one arrangement of antenna assembly 230 in communication with a PCB 240 is shown in FIG. 7.

In this embodiment, antenna 220a is formed of a copper pattern directly on the main PCB 240 of the product, which in this case is a modem (not shown). Antennas 220b and 220c are formed as individual PCB units respectively and these are mounted using a simple soldering operation on the edge of PCB 240.

It will be clearly understood that whilst FIG. 7 shows antennas 220b and 220c mounted using a simple soldering operation on the edge of PCB 240, the antennas 220b and 220c can be mounted on PCB 240 in a variety of ways including, but not limited to, soldered on the surface of the PCB 240 or soldered in place within a slot cut in the PCB 240.

In this embodiment, all three antennas 220a, b and c are connected to the radio frequency (RF) integrated chip (IC) 242 of the modem (not shown) by microstrip transmission lines 244 which form part of the main PCB 240.

It will be understood clearly that whilst antenna 220a is shown as being formed of a copper pattern directly on the main PCB 240, the antenna 220a can be manufactured separately mounted upon a low loss material which is then soldered directly to the main PCB 240 in such a way that it lies flat on the main PCB 240 or it can be arranged so as to be in parallel and adjacent to the PCB 240.

By using wireless assembly 30, as detailed with reference to any one of the above embodiments, within an MxN MIMO system, when there are L=N antennas, excellent performance can be achieved within the wireless communications system.

In the situation when L antennas are employed within an MxN MIMO system, with multiple wirelessly connected devices, and L>N, the N out of L antennas are chosen to be active at any one time by an antenna switching mechanism (not shown) implemented within the wireless antenna assembly. In this case, the switching mechanism is an appropriate algorithm. The same is true if L>M. However, the mechanism of selecting any N out of L antenna elements is not always practically viable due to imposed cost limits, complexity of the switching mechanism and loss of power which occurs by inclusion of such a radio frequency switching system.

In an embodiment shown in FIG. 8, there is shown a schematic representation of a modem 350 provided with a wireless antenna assembly 330 provided with six antennas 324 a, a′, b, b′, c, c′ with the antennas of each pair 324a, a′, 324b, b′ and 324c, c′ arranged in parallel along the same axis. A switching unit 326 is formed between modem 350 and the antennas 324 a, a′, b, b′, c, c′. The switching unit 326 comprises connection 337a which is provided between modem 350 and switch 338a, whereby the switch 338a can form a connection between modem 350 and selectively one of antennas 324a or 324a′. A connection 337b is provided between modem 350 and switch 338b, whereby the switch 338b can form a connection between modem 350 and selectively one of antennas 324b or 324b′. Furthermore, a connection 337c is provided between modem 350 and switch 338c, whereby the switch 338c can form a connection between modem 350 and selectively one of antenna assemblies 324c or 324c′.

An embodiment of wireless assembly 330 is shown in FIG. 9 and comprises a wireless network unit 332 which is a cube of which surfaces 334a, 334b and 334c can be seen with surface 334a orientated as to be orthogonal to the x-axis; surface 334b orientated to be orthogonal to the z-axis and surface 334c orientated to be orthogonal to the y-axis. Upon each of surfaces 334a, 334b and 334c is provided a patch antenna unit 320a, 320b and 320c, such as the patch antenna unit of FIG. 2. In addition, the unit 332 is provided with surfaces 334d, 334e and 334f (not shown) with surface 334d orientated as to be orthogonal to the x-axis and opposing surface 334a; surface 334e orientated to be orthogonal to the z-axis and opposing surface 334e and surface 334f orientated to be orthogonal to the y-axis and opposing surface 334c. Upon each of surfaces 334d, 334e and 334f is provided a patch antenna unit 320a′, 320b′ and 320c′, such as the patch antenna unit of FIG. 2. The antennas 324 a, a′, b, b′, c, c′ are arranged orthogonally to one another such that, in use, the directions of maximum radiated power from the wireless antenna assembly 30 are mutually orthogonal with one antenna facing in each of the six spatial directions, x, y, z, −x, −y, −z.

Referring again to FIG. 8 in conjunction with FIG. 9, each antenna in a pair, for example 324a and 324a′ is provided with the same polarisation but with the polarisation but facing in opposite directions to one another. This is true for the remaining pairs 324b, b′ and 324c, c′ meaning that the antennas 324 a, a′, b, b′, c, c′ are arranged such that the polarisation of adjacent antennas is always orthogonal.

The restricted switching scheme provided by switching unit 326 guarantees that the polarisations of the antennas operating in the assembly 330 at any give time, in this embodiment antennas 324a, 324b′ and 324c′ are selected, are mutually orthogonal. In addition, by restricting each pair of antennas 324a, a′, 324b, b′ and 324c, c′ to the same axis ensures the system is effective in minimising cross correlation.

A mechanism (not shown) for selecting the best antenna of each pair 324a, a′, 324b, b′ and 324c, c′ determines criteria including, but not limited to, received signal strength, data packet loss occurring and other measures of radio performance. The modem 250 utilises the mechanism during an initial training phase when the modem 250 first becomes operational, and then repeats use of the mechanism at intervals thereafter, according to a predetermined schedule or specific alerts upon subsequent radio performance thus ensuring that the most appropriate antennas are operational.

The mechanism can similarly be applied in the case of multiple clients where the best choice of antennas is selected on a per client basis which requires packet-by-packet switching. In cases where it is not practical to switch on a packet-by-packet basis, perhaps due to the design of the software controlling the access point to the wireless network system (not shown), then the set of best antenna choices is aggregated to produce an optimal compromise choice of antennas. It will be further understood that the mechanism can be implemented in a wireless assembly having any number of antennas provided the antennas are each of mutually orthogonal polarisation.

Although aspects of the invention have been described with reference to the embodiment shown in the accompanying drawings, it is to be understood that the invention is not limited to the precise embodiment shown and that various changes and modifications may be effected without further inventive skill and effort, for example, the wireless antenna assembly may be provided with any number of antennas between two and six inclusive. In addition, any suitable materials can be used to manufacture the wireless antenna assembly and/or antenna.

1. An antenna assembly for a wireless communications device, the assembly comprising:
a first antenna having a first direction of maximum radiated power; and
a second antenna having a second direction of maximum radiated power, wherein the first and second antennas are arranged such that the first and second directions are substantially mutually orthogonal.

2. An antenna assembly as claimed in claim 1, wherein the first and second antennas have respective directions of polarization, and wherein those directions of polarization are substantially mutually orthogonal.

3. An antenna assembly as claimed in claim 1, further comprising a third antenna having a third direction of maximum radiated power, wherein the third antenna is arranged such that the third direction of maximum radiated power is substantially orthogonal to the first and second directions.

4. An antenna assembly as claimed in claim 3, wherein the third antenna has a direction of polarization which is substantially orthogonal to each of the first and second directions of polarization.

5. An antenna assembly as claimed in claim 3, further comprising at least one antenna in addition to the first, second and third antennas, the assembly being operable to select for operation a subset of the antennas, the subset comprising antennas that have substantially mutually orthogonal directions of maximum radiated power.

6. An antenna assembly as claimed in claim 1, wherein each antenna is a high gain antenna.

7. An antenna assembly as claimed in claim 1, where each antenna is a directional antenna.

8. An antenna assembly as claimed in claim 1 wherein the antenna assembly includes a body or unit with a plurality of surfaces thereon and on at least a plurality of said surfaces are provided an antenna.

9. An antenna assembly as claimed in clam 8 wherein the antennas are provided on respective surfaces of a cube or cuboid or right-angled parallelepiped or regular hexahedron shaped body or unit.

10. An antenna assembly as claimed in claim 1, wherein each antenna is resonant in dual frequencies.

11. An antenna assembly as claimed in claim 1, wherein the antenna assembly is provided with up to six antennas.

12. An antenna assembly as claimed in claim 9, wherein the antenna provided on opposing surfaces of a cube have respective polarisations which are on a shared axis but in opposing directions.

13. An antenna assembly as claimed in claim 1, wherein the assembly is implemented in a transmitter device.

14. An antenna assembly as claimed in claim 1 wherein the assembly is implemented in a receiver device.

15. A wireless communications device, said device comprising:
an antenna assembly having a first antenna having a first direction of maximum radiated power; and having a second antenna having a second direction of maximum radiated power, wherein the first and second antennas are arranged such that the first and second directions are substantially mutually orthogonal.

16. A wireless communications system wherein the system includes a receiver device and a transmitter device and wherein an antenna assembly is provided as part of the receiving device and/or as part of the transmitter device, the antenna assembly having a first antenna having a first direction of maximum radiated power; and having a second antenna having a second direction of maximum radiated power, wherein the first and second antennas are arranged such that the first and second directions are substantially mutually orthogonal.

17. An antenna assembly as claimed in claim 3 wherein each antenna is a high gain antenna.

18. An antenna assembly as claimed claim 3, where each antenna is a directional antenna.

19. An antenna assembly as claimed in claim 3, wherein each antenna is resonant in dual frequencies.
